(19) United States
(12) Patent Application Publication
(10) Pub. No.: US 2005/0001842 A1
(43) Pub. Date: Jan. 6, 2005

(54) Method, system and computer program product for predicting an output motion from a database of motion data

(76) Inventors: Woojin Park, Blue Ash, OH (US); Donald B. Chaffin, Ann Arbor, MI (US); Bernard J. Martin, Ann Arbor, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/851,783

(22) Filed: May 21, 2004

Related U.S. Application Data
(60) Provisional application No. 60/473,183, filed on May 23, 2003.

(51) Int. Cl. G06T 15/70

(52) U.S. Cl. 345/474

(57) ABSTRACT

A method, system and a computer program product for accurately predicting an output motion from a database of motion data based upon an input motion scenario are provided. A motion database is searched to find relevant existing motions. The selected motions, referred to as “root motions,” most likely do not meet exactly the input motion scenario, and therefore, they need to be modified by an algorithm. This algorithm derives a parametric representation of possible variants of the root motion in a GMP-like manner, and adjusts the parameter values such that the new modified motion satisfies the input motion scenario, while retaining the root motion's overall angular movement pattern and inter-joint coordination. The embodiment of the invention can accurately predict various human motions with errors comparable to the inherent variability in human motions when repeated under identical task conditions. The motions may be human or non-human such as other living creatures or robot motions.

### CROSS-REFERENCE TO RELATED APPLICATION

This application claims the benefit of U.S. provisional application Ser. No. 60/473,183, filed May 23, 2003.

### BACKGROUND OF THE INVENTION

1. Field of the Invention

The present invention relates to methods, systems and computer program products for predicting an output motion from a database of motion data.

2. Background Art

The following references are noted herein:
[1] D. B. Chaffin, “Digital Human Modeling for Vehicle and Workplace Design,” Warrendale, Pa.: SAE, 2001.
[2] G. D. Jimmerson, “Digital Human Modeling for Improved Product and Process Feasibility Studies,” in DIGITAL HUMAN MODELING FOR VEHICLE AND WORKPLACE DESIGN, D. B. Chaffin, Ed. Warrendale, Pa.: SAE, 2001.
[3] J. W. McDaniel, “Models for Ergonomic Analysis and Design: COMBIMAN and CREWCHIEF,” in COMPUTER-AIDED ERGONOMICS, W. Karowowski et al., Eds. New York: Taylor & Francis, 1990.
[4] J. M. Porter et al., “Computer-aided Ergonomics Design of Automobiles,” in AUTOMOTIVE ERGONOMICS, B. Peacock et al., Eds. New York: Taylor & Francis, 1993.
[5] G. Salvendy, Ed., HANDBOOK OF INDUSTRIAL ENGINEERING. New York: Wiley, 2001. U. Raschke et al., “Simulating Humans: Ergonomic Analysis in Digital Environments.”
[6] D. Bowman, “Using Digital Human Modeling in a Virtual Heavy Vehicle Development Environment,” in DIGITAL HUMAN MODELING FOR VEHICLE AND WORKPLACE DESIGN, D. B. Chaffin, Ed. Warrendale, Pa.: SAE, 2001.
[7] S. M. Hsiang et al., “Development of Methodology in Biomechanical Simulation of Manual Lifting,” INT. J. INDUST. ERGON., vol. 19, pp. 59-74, 1994.
[8] J. D. Ianni, “Human Model Evaluations of Air Force System Designs,” in DIGITAL HUMAN MODELING FOR VEHICLE AND WORKPLACE DESIGN, D. B. Chaffin, Ed. Warrendale, Pa.: SAE, 2001.
[9] E. S. Jung and J. Choe, “Human Reach Posture Prediction Based on Psychophysical Discomfort,” INT. J. INDUST. ERGON., vol. 18, pp. 173-179, 1996.
[10] E. S. Jung et al., “Upperbody Reach Posture Prediction For Ergonomics Evaluation Models,” INT. J. INDUST. ERGON., vol. 16, pp. 95-107, 1995.
[11] C. Nelson, “Anthropometrie Analyzes of Crew Interfaces and Component Accessibility for the International Space Station,” in DIGITAL HUMAN MODELING FOR VEHICLE AND WORKPLACE DESIGN, D. B. Chaffin, Ed. Warrendale, Pa.: SAE, 2001.
[12] D. D. Thompson, “The Determination of the Human Factors/occupant Packaging Requirements for Adjustable Pedal Systems,” in DIGITAL HUMAN MODELING FOR VEHICLE AND WORKPLACE DESIGN, D. B. Chaffin, Ed. Warrendale, Pa.: SAE, 2001.
[13] T. Flash, “The Organization of Human Arm Trajectory Control,” in MULTIPLE MUSCLE SYSTEMS: BIOMECHANICS AND MOVEMENT ORGANIZATION, J. Winters and S. Woo, Eds. New York: Springer-Verlag, 1990.
[14] M. Kawato, “Trajectory Formation in Arm Movements: Minimization Principles and Procedures,” in ADVANCES IN MOTOR LEARNING AND CONTRL, H. N. Zelaznik, Ed. Champaign, Ill.: Human Kinetics, 1996.
[15] W. Abend et al., “Human Arm Trajectory Formation,” BRAIN, vol. 105, pp. 331-348, 1982.
[16] R. M. Alexander, “A Minimum Energy Cost Hypothesis for Human Arm Trajectory,” BIOL. CYBERN., vol. 76, pp. 97-105, 1997.
[17] T. Flash et al., “The Coordination of Arm Movements: an Experimentally Confirmed Mathematical Model,” J. NEUROSCI., vol. 5, pp. 1688-1703, 1985.
[18] M. I. Jordan, “Motor Learning and the Degrees of Freedom Problem,” in ATTENTION AND PERFORMANCE XIII, M. Jeannerod, Ed. Hillsdale, N.J.: Lawrence Erlbaum, 1990.
[19] M. Kawato, “Optimization and Learning in Neural Networks for Formation And Control of Coordinate Movement,” in ATTENTION AND PERFORMANCE, XIV: SYNERGIES IN EXPERIMENTAL PSYCHOLOGY, ARTIFICIAL INTELLIGENCE, AND COGNITIVE NEUROSCIENCE—A SILVER JUBILEE, D. Meyer and S. Kornblum, Eds. Cambridge, Mass.: MIT Press, 1992.
[20] D. A. Rosenbaum et al., “Coordination of Reaching and Grasping by Capitalizing on Obstacle Avoidance and Other Constraints,” EXPER. BRAIN RES., vol. 128, pp. 92-100, 1999.
[21] D. A. Rosenbaum et al., “Planning Reaches by Evaluating Stored Postures,” PSYCHOL. REV., vol. 102, pp. 28-67, 1995.
[22] D. A. Rosenbaum et al., “Posture-based Motion Planning: Applications to Grasping,” PSYCHOL. REV., vol. 108, pp. 709-734, 2001.
[23] J. E Soechting et al., “Moving Effortlessly in Three Dimensions: Does Donders Law Apply to Arm Movements?,” J. NEUROSCI., vol. 15, pp. 6271-6280, 1995.
[24] Y. Uno et al. “Formation and Control of Optimal Trajectory in Human Multijoint Arm Movement—Minimum Torque-change Model,” BIOL. CYBERN., vol. 61, pp. 89-101, 1989.
[25] C. Chang et al., “Biomechanical Simulation of Manual Lifting Using Spacetime Optimization,” J. BIOMEC., vol. 34, pp. 527-532, 2001.
[26] C. J. Lin et al., “Computer Motion Simulation For Sagittal Plane Lifting Activities,” INT. J. INDUST. ERGON., vol. 24, pp. 141-155, 1999.
[27] X. Zhang et al., “A Three-dimensional Dynamic Posture Prediction Model for In-vehicle Seated Reaching Movements: Development And Validation,” ERGONOMICS, vol. 43, pp. 1314-1330, 2000.
[28] X. Zhang et al., “Optimization-based Differential Kinematic Modeling Exhibits a Velocity-control Strategy for Dynamic Posture Determination in Seated Reaching Movements,” J. BIOMECH., vol. 31, pp. 1035-1042, 1998.
[29] J. J. Faraway, “Regression Analysis for Functional Response,” TECHNOMETRICS, vol. 3, pp. 254-261, 1997.
[30] R. A. Schmidt et al., “Motor Control and Learning: a Behavioral Emphasis,” Champaign, Ill.: Human Kinetics, 1999.
[31] A. Bruderlin et al., “Motion Signal Processing,” in PROC. SIGGRAPH CONF., 1995, pp. 97-104.
[32] M. Gleicher, “Retargeting Motion to New Characters,” in PROC. CONF. SIGGRAPH, 1998, pp. 33-42.
[33] M. Gleicher et al., “Constraint-based Motion Adaptation,” J. Vis. COMPUT. ANIMAT., vol. 9, pp. 65-94, 1998.
[34] J. Lee et al., “A Hierarchical Approach to Interactive Motion Editing for Human-like Figures,” in PROC. SIGGRAPH CONF., 1998.
[35] A. Witkin et al., “Motion Warping,” in PROC. SIGGRAPH CONF., 1995.

Human CAD systems bring digital humans to the traditional CAD world in order to improve human-machine/environment interactions. Designers can create initial prototypes of products and workcells, and test their ergonomic correctness prior to building hardware prototypes. Such human CAD systems are reported to reduce product development cycles and enhance the number and quality of design options [1]-[5].

One of the most desired functions of human CAD systems is accurate simulation/prediction of human motions [1], [2], [6]-[12], as it is a basis of many virtual ergonomic analyses, such as biomechanical low back stress, reachability, visibility, discomfort, and clearance analyses. Redundancy, caused by the large degrees of freedom inherent in the human body, is the critical problem in predicting realistic human motions (see [13], [14] for review). The way in which a given posture or a pattern of joint motion trajectories is determined to perform a goal-directed movement task is not clearly understood. Simulation modeling of motions helps gain insights into human motion planning, and is extensively utilized as a research methodology for testing various biological hypotheses [13]-[24].

Several approaches have been proposed for ergonomic human motion simulation. Space-time optimization models were developed to predict two-dimensional (2-D) human lifting motions by minimizing biomechanical joint stresses given initial and final postures [7], [25], [26]. Differential inverse kinematic methods have been utilized to predict upperbody reach motions [9], [10], [27], [28]. The primary goal of these studies was to model how the movement of the hand (or end-effector) in the Cartesian space translates into the rotational movements of body segments. Faraway [29] developed a statistical method for predicting human reach motions based on regression models fitted to large sets of real motions. Given an ensemble of parameters, including the performer's stature, age, gender, etc., and the reach target location, the regression models predict the “average” joint angle trajectories and the corresponding confidence envelopes. In addition to ergonomic simulation models, various models have been developed to understand human motor planning and control [14], [16]-[19], [21], [22], [24]. These models were used to study relatively simple motions of two/three-link systems or planar motions.

Despite some success, the previous models are limited, as they do not account for some fundamental human motor capabilities.
1) Generality: How to predict motions of different categories (lifting, reaching, load transferring, etc.) with a single, unified model.
2) Accommodation of movement alternatives: How to simulate stylistically different motions associated with a single task goal (e.g., stoop and squat techniques for lifting).
3) Expandability: How to expand the motion repertoire by adding new motor skills.

Hence, there is a need for a model structure that has the above capabilities to enhance the utility of digital humans as an engineering design tool, and also will further the understanding of human motion planning.

### SUMMARY OF THE INVENTION

An object of the present invention is to provide a method, system and a computer program product for predicting an output motion from a database of motion data having at least one of the above capabilities, and preferably, all of the above capabilities.

In carrying out the above object and other objects of the present invention, a method for predicting an output motion from a database of motion data is provided. The method includes receiving inputs which represent an input motion scenario and receiving motion data retrieved from the database. The motion data represents an existing motion of an existing motion scenario similar to the input motion scenario. The method further includes modifying the motion data based on the inputs to predict the output motion. The output motion substantially satisfies the input motion scenario and also substantially retains at least one property of the existing motion.

The at least one property may be overall angular movement pattern of the existing motion.

The at least one property may be inter-joint coordination of the existing motion.

The existing motion may be represented as a set of joint angle trajectories.

The step of modifying may include the step of resolving each joint angle trajectory into geometric primitive segments.

Motions may be human motions.

The step of modifying may be performed in the angle-time domain.

The input motion scenario may include a set of attributes which describe a performer and a task.

The set of attributes which describe the performer may include at least one of stature, body weight, age and gender.

The set of attributes which describe the task may include at least one of motion type, goals of the motion and hand-held object characteristics.

The goals of the motion may be represented as a set of locations and orientations.

Each joint angle trajectory may be resolved to obtain a plurality of segments and segment boundary points, and the step of resolving may include the step of relocating the segment boundary points in the angle-time domain to obtain a new set of segment boundary points. The step of resolving may further include the steps of shifting and proportionately rescaling the segments to obtain new segments and fitting the new segments through the new set of segment boundary points.

The method may further include searching the database based on the inputs to retrieve the motion data.

Further in carrying out the above object and other objects of the present invention, a system for predicting an output motion from a database of motion data is provided. The system includes means for receiving inputs which represent an input motion scenario, and means for receiving motion data retrieved from the database. The motion data represents an existing motion of an existing motion scenario similar to the input motion scenario. The system further includes means for modifying the motion data based on the inputs to predict the output motion. The output motion substantially satisfies the input motion scenario and also substantially retains at least one property of the existing motion.

The means for modifying may be performed in the angle-time domain.

Each joint angle trajectory may be resolved to obtain a plurality of segments and segment boundary points, and the means for resolving may include means for relocating the segment boundary points in the angle-time domain to obtain a new set of segment boundary points. The means for resolving may further include means for shifting and proportionately resealing the segments to obtain new segments and means for fitting the new segments through the new set of segment boundary points.

The system may further include means for searching the database based on the inputs to retrieve the motion data.

Still further in carrying out the above object and other objects of the present invention, a computer program product includes a computer-readable medium, having thereon computer program code means, when the program is loaded, to make the computer execute procedure: a) to receive inputs which represent an input motion scenario; b) to receive motion data retrieved from a database wherein the motion data represents an existing motion of an existing motion scenario similar to the input motion scenario; and c) to modify the motion data based on the inputs to predict the output motion wherein the output motion substantially satisfies the input motion scenario and also substantially retains at least one property of the existing motion.

The code means may further make the computer execute procedure to search the database based on the inputs to retrieve the motion data.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic block diagram flow chart of one embodiment of a memory-based motion simulation system of the present invention;

FIGS. 2a and 2b are graphs of a root motion containing two joint angles and showing segmentation of the joint angles; the hollow squares represent the identified segment boundary points; the shapes of joint angle trajectories are represented by the strings “UDS” (top) and “DUD” (bottom);

FIG. 3 are graphs showing a variant of a root motion obtained by relocating segment boundary points and deforming the root motion accordingly; the joint angle trajectories are represented by solid and dashed lines for the root and the modified motion, respectively; empty squares and circles represent the segment boundary points of the root and modified motion, respectively; and

FIGS. 4a and 4b are graphs showing a root motion (FIG. 4a) and a modified motion for the new target (FIG. 4b) wherein the Figures collectively show an example of standing reach-and-grasp motion modification (Oblique View); the kinematic linkage system was composed of 45 degrees-of-freedom; only the final postures are shown for the clarity of the illustration.

### DETAILED DESCRIPTION OF THE PREFERRED EMBODIMENTS

The generalized motor program (GMP) theory [30] states that movement patterns, called motor programs, are stored in human memory and are utilized as templates for motion planning. Parameters such as movement duration and amplitude can be modified to adjust a selected motor program as a function of the task to perform. The GMP theory seems to provide the plasticity necessary to address the issues stated above, namely, generality, accommodation of movement alternatives, and repertoire expansion, as the human memory can be thought of as capable of storing motor programs of various motion types and styles, as well as continually updating them. The theory therefore seems to provide a desirable model structure for developing useful ergonomic human motion simulation models.

Recent studies in the computer graphics field also support the feasibility of GMP-based human motion prediction models. Motion editing/adaptation/retargeting methods, developed for computer game animation and digital movie making, alter existing motion samples using signal processing techniques and spline interpolations to bring about certain visual effects, and fit motions to newly given via-points in a motion trajectory [31]-[35]. Although these methods neither have biological bases nor intend to predict human motions accurately, they demonstrated that utilizing existing motion patterns to generate visually convincing new motions is feasible.

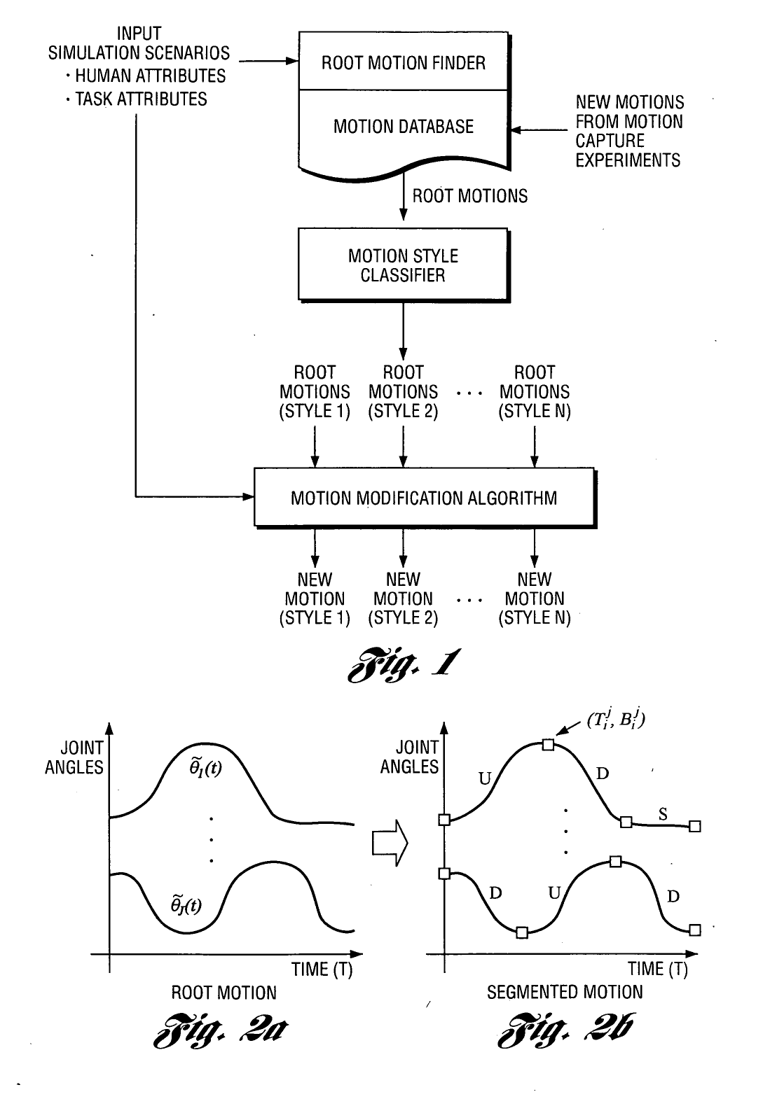

Inspired by the GMP theory, one embodiment of the present invention utilizes a memory-based motion simulation (MBMS) approach. An MBMS system may be composed of three basic elements: a motion database, a motion finder, and a motion modification algorithm. As shown in FIG. 1, another embodiment of the present invention may also include a motion style classifier. However, the present invention need not include such a classifier. The database is a collection of real human motions obtained from a large array of motion capture experiments. Each motion is represented by a set of joint angle “trajectories” associated with a specific motion scenario. A motion scenario includes attributes describing the performer (stature, body weight, age, gender, etc.) and the task (motion type, goal, initial and final hand positions, object in the hand, etc.).

When a novel motion scenario is input to the system, the motion finder searches the motion database to find existing similar motions, using rules based on measures of similarities between the input motion scenario and the scenarios of the existing motions. These existing motions, termed root motions, are adapted or modified by the algorithm to meet the simulation scenario.

One embodiment of the present invention aims to:
1) provide an accurate human motion prediction tool for computer-aided ergonomic task design; and
2) provide a new computer model of human motion planning based on the GMP theory.

Three types of input data are assumed to be given to predict or simulate a motion via motion modification:
1) anthropometric body segment dimensions, L=[l₁, . . . l_{L}];
2) the description of the task goals in terms of initial (E₀) and final (E_{T}) location and orientation of the end-effector; and
3) a root motion represented as a set of joint angle trajectories, \tilde{θ}(t)=[\tilde{θ}ₗ(t) . . . \tilde{θ}ⱼ(t) . . . \tilde{θ}_{J}(t)]^{T}, where j is the index for J body joint degrees of freedom (j=1, . . . , J) and t represents time in [0, T].

The output motion to be generated is a modification of \tilde{θ}(t) denoted as \hat{θ}(t)=[\hat{θ}ₗ(t) . . . \hat{θ}ⱼ(t) . . . \hat{θ}_{J}(t)]^{T}, and must satisfy the initial and final postural constraints
F(\hat{θ}(0), L)=E₀ (1)
F(\hat{θ}(T), L)=E_{T} (2)
where F represents the forward kinematics equation of the linkage system L being moved.

Motion modification is intended to alter a root motion according to numerous new simulation scenarios. To do so, certain parameters are required to control changes imposed to the root motion. Therefore, for the proposed modification algorithm, a parameterization scheme was developed to modify root motions in the angle-time domain. Here, joint angle trajectories of a root motion are first processed by a segmentation algorithm, as described in detail in the Appendix hereto. This algorithm resolves each joint angle trajectory into geometric primitive segments labeled “U” (monotonically increasing segment), “D” (monotonically decreasing segment), or “S” (stationary segment). Hence, the overall shape of a joint angle trajectory is described by a string of characters, and a motion is represented by a set of strings; one for each joint angle trajectory. FIGS. 2a and 2b illustrate the concept, with the segment boundary points shown as squares.

The segment boundary points identified on each joint angle trajectory are utilized as control parameters for modification. To derive a variant of the root motion, the segment boundary points are first relocated in the angle-time space. The original and the new locations of the segment boundary points are denoted as (Tᵢ^{j}, Bᵢⁱ), and (τᵢ^{j}, βᵢ^{j}), respectively, where j is the index of the segment boundary points (i=1, . . . , Iⱼ)
τᵢ^{j}=Tᵢ^{j}+ΔTᵢ^{j} and
βᵢ^{j}=Bᵢ^{j}+ΔBᵢ^{j}. (3)

A modified motion can be generated by shifting and proportionally resealing individual segments of the joint angle trajectories of the root motion and then fitting the trajectories through the new sets of segment boundary points. This local proportional scaling preserves Cl-continuities of joint angle trajectories of a root motion in deriving its variants, since: 1) within a motion segment, proportional scaling does not breach existing Cl-continuity; and 2) proportional-scaling does not change zero time-derivative values at segment boundary points. Thus, smooth transitions between adjacent segments are ensured.

The new motion trajectory \hat{θ}(t) at a given time t (τᵢ^{j}≦t≦τᵢ₊₁^{j}) can be represented by:

$$\begin{matrix}\hat{{θ}_{j}} ( t ) = {β}_{i}^{j} + \frac{{β}_{i + 1}^{j} - {β}_{i}^{j}}{{B}_{i + 1}^{j} - {B}_{i}^{j}} \times \\ ( \tilde{θ} ( {T}_{i}^{j} + \frac{{T}_{i + 1}^{j} - {T}_{i}^{j}}{{τ}_{i + 1}^{j} - {τ}_{i}^{j}} ( t - {τ}_{i}^{j} ) ) - {B}_{i}^{j} ) \\ when \\ {B}_{i + 1}^{j} - {B}_{i}^{j} \neq 0 , \\ and \\ {\hat{θ}}_{j} ( t ) = {β}_{i}^{j} , \\ when \\ {B}_{i + 1}^{j} - {B}_{i}^{j} = 0.\end{matrix} \qquad ( 4 )$$

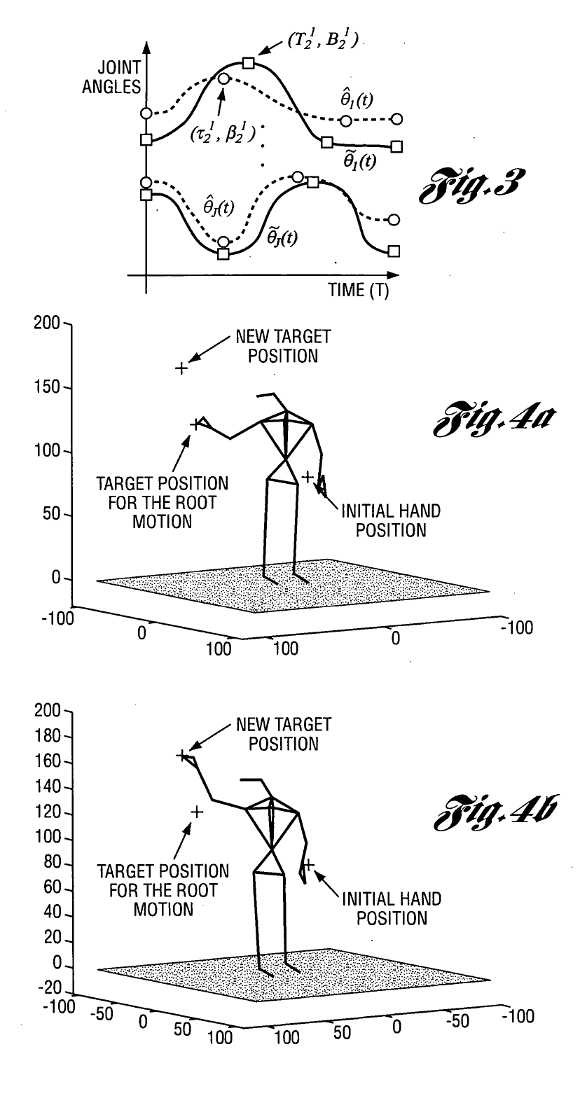

An example of variant from a root motion is illustrated in FIG. 3.

Possible new locations of segment boundary points (τᵢ^{j}, βᵢ^{j}) are bound by the following constraints:

The new segment boundary points should not:
1) change the order of events in time: τᵢ₊₁^{j}>τᵢ^{j} for all j and i (order of event constraint);
2) change the shape of joint angle trajectories. In other words, the shape-representing alphabetic string should remain the same (angle trajectory shape constraint);
3) violate the joint range of motion constraints (joint range of motion constraint).

Also, the duration of the movements is normalized to [0, T], hence, τᵢ^{j}=0 and τₗ_{ⱼ}^{j}=T for all j.

The parameterization scheme maps a root motion into a motion family constituted by the root motion's possible variants. The variants retain the root motion's properties such as the smoothness and the spatial-temporal movement patterns commonly known as invariant features of GMPs [30].

To solve a particular motion modification problem, the new segment boundary point locations (τᵢ^{j}, βᵢ^{j}) should be set so that the modified motion satisfies the task goal constraints stated in (1) and (2). Each of (1) and (2) provides at most six constraints (three for hand position and three for hand orientation). However, the number of parameters to be determined (coordinates of all segment boundary points) exceeds the number of constraints and allows an infinite number of possible solutions. To resolve the redundancy problem, a minimum dissimilarity principle is proposed. Among all possible variants of the root motion that satisfy (1) and (2), one that resembles the root motion the is selected.

In essence, the proposed motion modification scheme consists of a two-step iteration; the initial and final postures are iteratively modified to satisfy (1) and (2), and the joint angle trajectories are then modified to link the modified initial and final postures. This process is repeated until all constraints are satisfied. The following describe each step.

1) In-Between Trajectory Modification Given New Initial and Final Postures: The in-between trajectory modification uses a root motion and a pair of new initial and final postures as input data and modifies the root motion to fit the new terminal postures. The determination of the new initial and final postures in a way that (1) and (2) are satisfied is described in the section.

Each joint angle trajectory of the root motion \tilde{θ}ⱼ(t) is modified individually to obtain a new joint angle trajectory, \tilde{θ}ⱼ(t), that links \tilde{θ}ⱼ(0) and \tilde{θ}ⱼ(T), the given initial and final joint angle values of the j-th joint angle trajectory of the new motion.

The parameterization scheme described in the previous section allows the problem to be defined in terms of segment boundary point location parameters. Since the new locations of the initial and final segment boundary points, (τₗ^{j}, βₗ^{j}) and (τₗ_{ⱼ}^{j}, βₗ_{ⱼ}^{j}), are given as τₗ^{j}=0, βₗ^{j}=\hat{θ}ⱼ(0), τₗ_{ⱼ}^{j}=T, and βₗ_{ⱼ}^{j}=\hat{θ}ⱼ(T), our goal is to determine the new locations of the nonterminal segment boundary points, (τᵢ^{j}, βᵢ^{j}) s for i=2, . . . , (Iⱼ−1).

When Iⱼ=2, \hat{θ}ⱼ(t) is completely determined by (4) from βₗ^{j} and βₗ_{ⱼ}^{j}. However, when Iⱼ>2, the locations of the nonterminal segment boundary points become indeterminate. To resolve this indeterminacy, the following minimization problem is solved:

$$\begin{matrix}Minimize {\int }_{0}^{T} {( {\dot{\hat{θ}}}_{j} ( t ) - {\dot{\tilde{θ}}}_{j} ( t ) )}^{2} ⅆ t \\ s . t . \\ {\hat{θ}}_{j} ( 0 ) and {\hat{θ}}_{j} ( T ) are given as constants .\end{matrix} \qquad ( 5 )$$

In (5), \hat{\dot{θ}}ⱼ(t), and \tilde{\dot{θ}}ⱼ(t) denote the first time derivatives of the new and the root joint angle trajectories, respectively. By solving (5), a new joint angle trajectory \hat{θ}ⱼ(t) is found that links \hat{θ}ⱼ(0) and \hat{θ}ⱼ(T) smoothly and also resembles \hat{θ}ⱼ(t) in the angular velocity domain.

Equation (5) can be restated as a function of segment boundary point parameters, βᵢ^{j} s and τᵢ^{j} s. The optimization problem is simplified by setting the occurrence times of the new segment boundary points equal to those of the segment boundary points of the root angle trajectory:
τᵢ^{j}=Tᵢ^{j} for all i (6)

The above simplification follows the minimum dissimilarity principle as it forces the timing of events in the modified and root joint angle trajectories to be identical. Hence, the inter-joint coordination of the root motion is retained in the new motion. With this simplification, the objective function in (5) can rewritten as:

$$\begin{matrix}{\int }_{0}^{T} {( \dot{\hat{{θ}_{j}}} ( t ) - \dot{\tilde{{θ}_{j}}} ( t ) )}^{2} ⅆ t \approx {\sum }_{i = 1}^{{I}_{j} - 1} ( {( {\hat{{υ}_{i}}}^{j} - {\tilde{{υ}_{i}}}^{j} )}^{2} \cdot {duration}_{i} ) \\ = {\sum }_{i = 1}^{{I}_{j} - 1} ( {( \frac{{β}_{i + 1}^{j} - {β}_{i}^{j}}{{T}_{i + 1}^{j} - {T}_{i + 1}^{j}} - \frac{{B}_{i + 1}^{j} - {B}_{i}^{j}}{{T}_{i + 1}^{j} - {T}_{i}^{j}} )}^{2} \times \\ ( {T}_{i + 1}^{j} - {T}_{i}^{j} ) )\end{matrix} \qquad ( 7 )$$

where \hat{υ}ᵢ^{j} and \tilde{υ}ᵢ^{j} denote the average joint angular velocity during the i-th segment, and durationᵢ denotes the time-duration of the i-th segment.

The optimal solution (βᵢ^{j} s) that minimizes the above objective function was found using calculus

$${β}_{i}^{j} = {B}_{i}^{j} + ( {β}_{1}^{j} - {B}_{1}^{j} ) \frac{( T - {T}_{i}^{j} )}{T} + ( {β}_{{I}_{j}}^{j} - {B}_{{I}_{j}}^{j} ) \frac{{T}_{i}^{j}}{T} . \qquad ( 8 )$$

The above solution does not guarantee maintenance of the shape of “S” segments, as it could rescale “S” segments. To prevent “S” segments from being rescaled, the solution was slightly modified to:

$${β}_{i}^{j} = {B}_{i}^{j} + ( {β}_{1}^{j} - {B}_{1}^{j} ) \frac{( {T}^{*} - {T}_{i}^{{j}^{*}} )}{{T}^{*}} + ( {β}_{{I}_{j}}^{j} - {B}_{{I}_{j}}^{j} ) \frac{{T}_{i}^{{j}^{*}}}{{T}^{*}} \qquad ( 9 )$$

where T* denotes the sum of durations of all the “U” and “D” segments, and Tᵢ^{j*} denotes the sum of durations of all the “U” and “D” segments included in [0, Tᵢ^{j}]. This solution rescales only “U” and “D” segments, and all “S” segments in a root motion remain the same after modification. The optimal βᵢ^{j} s from (9) completely determine \tilde{θ}ⱼ(t) for 0≦t≦T with (4).

2) Initial and Final Posture Modification: The initial and final postures of the modified motion, βₗ and βₗ (or equivalently, \hat{θ}(0) and \hat{θ}(T)), must satisfy (1) and (2). Equations (1) and (2) can be rewritten as:
Gₗ(βₗ)=∥F(βₗ, L)−E₀∥=0 (10)
Gₗ(βₗ)=∥F(βₗ, L)−E_{T}∥=0. (11)

Each of the above equality constraints represents an inverse kinematics problem with redundant degrees of freedom. In order to resolve the redundancy, the minimum dissimilarity principle is adopted: The new initial (or final) posture should be chosen such that it resembles the initial (or final) posture of the root motion as much as possible while satisfying the constraints. Such new initial and final postures can be found by modifying the corresponding postures of the root motion using the following iterative update scheme:

$${β}^{new} = {β}^{prev} - α \frac{∇ G ( {β}^{prev} )}{‖ ∇ G ( {β}^{prev} ) ‖} \qquad ( 12 )$$

where ∇G represents the gradient of the function G (either Gₗ or Gₗ) and α represents a step-length parameter for each update. In (12), −∇G/∥∇G∥ indicates the direction of infinitesimal postural change that reduces the function G the greatest, and thus approaches the state of satisfying (10) or (11) with minimum infinitesimal postural change.

Equation (12) was further modified to take into consideration the fact that different body joints may have different degrees of motility. The joint with more motility in the root motion are modified more during the posture update. This assumption is implemented by introducing weighting factors

$${β}^{new} = {β}^{prev} - α \frac{W \cdot ∇ G ( {β}^{prev} )}{‖ W \cdot ∇ G ( {β}^{prev} ) ‖} \qquad ( 13 )$$

where W=[wₗ . . . wⱼ . . . w_{J}] represents weighting factors for each joint. The weighting factors are estimated by:
wⱼ=MAX(\tilde{θ}ⱼ(t))−MIN(\tilde{θ}ⱼ(t)) where tε[0, T]. (14)

The initial and final posture updates continue simultaneously until both (10) and (11) are satisfied (until Gₗ and Gₗ become smaller than a small user-defined threshold). For each iteration, the entire motion can be recalculated using (4) and (9). If the rent update of the initial and final postures and the recalculated motion from (4) and (9) violate any shape maintenance or joint range of motion constraint for a particular joint, the algorithm undoes the update at that particular joint so as to ensure the satisfaction of constraints and proceeds to the next iteration.

FIGS. 4a and 4b show an example of a human reach motion modification using the above-described embodiment of the present invention. In particular, a standing reach-and-grasp motion was modified to predict or generate a new motion for a new target position approximately 45 cm away from that of the root motion. The kinematic linkage has 45 degrees-of-freedom in this example.

The above-described embodiment of the present invention bears some similarities to the computer animation techniques known as motion editing/adaptation/retargeting methods [31]-[35] in that it reuses existing motion samples to create new ones. However, the proposed method differs from these animation techniques and provides unique benefits, mainly in two aspects. First, the method is intended to predict human motions accurately. The animation techniques, on the contrary, aimed to create visually convincing animations and visual effects for computer game development and digital movie making and their prediction capabilities have not been tested empirically through a comparison with actual human motions. The prediction accuracy of the embodiment of the present invention makes the method qualified for use in computer-aided ergonomic analyses, such as biomechanical low back stress, reachability, visibility, discomfort and clearance analyses.

Second, the method of the present invention is a human performance model based on a biological theory that helps test hypotheses on human motion planning while animation techniques are based on the esthetic of a visual perception. These different methods are not meant to compete but rather should be understood as solving different research problems while collectively suggesting a fundamental principle involved in human or human-like motion planning.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

### APPENDIX

### Symbolic Structure Representation of Human Motions

Symbolic Structure Representation of Human Motions

Raw motion data are normally represented as time-series. The structure of a time-series is revealed when segmentation of the time-series is performed to meet the following conditions:
Each segment represents monotonically increasing, monotonically decreasing, or stationary time trajectory, and
The number of segments is at minimum.

The term ‘structure’ of a time-series refers to segments determined according to the above conditions, their shape (monotonically increasing, decreasing, or stationary over time), and their arrangement in time. A human motion is normally described as multi-dimensional time-series, as there are multiple degrees of freedom varying over time (e.g. a number of joint angle trajectories, a number of joint center location trajectories, etc.). Human motions are described as multiple joint angle trajectories herein. The structure of a human motion then can be defined as a collection of the structures of individual joint angle trajectories.

Given the above definitions of structure, symbols are used to designate the structure of human motions. The logic is:
To divide a time-series into segments according to the definition (given above) of structure, and
To assign a symbol (‘U’: up, ‘D’: down, or ‘S’: stationary) to each segment of the time-series to describe its shape.

When a kinematic/kinetic motion trajectory is indexed as a string, each symbol in a string would correspond to a meaningful unit of motor activity. For example, a string “UDUD” representing the structure of an elbow joint angle trajectory means a sequence of primitive elbow joint motions “flexion-extension-flexion-extension.”Also, a string of symbols can be regarded as an abstraction of the overall shape of a time-series, which is presented in a parsimonious and understandable manner.

A Computer Algorithm for Symbolically Encoding Joint Angle Time Trajectories

In order for the symbolic structure coding scheme to be useful in dealing with voluminous motion data, the segmenting and coding tasks must be automated. Implementing such a computer algorithm, however, required consideration of the following issues: 1) experimentally collected time-series always contain ambiguities due to random noise which hinder the determination of segment boundaries, and 2) symbol assignment to resulting segments can be ambiguous as it is not clear how to determine whether a segment represents a significant motion (‘U’ or ‘D’) or a stationary state (‘S’).

The following is the detailed description of the algorithm.

Find Landmarks in the Time-Series (Step 1)

It is assumed that a uni-dimensional time-series xₜ (t=1, . . . , T) is given as the input data for the algorithm. Any appropriate filtering or smoothing operation can be applied to the time-series beforehand.

The algorithm begins by detecting all data points in the time-series which may be used to form segments. These data points are called landmarks. Landmarks are only candidates for segment boundaries in the subsequent segmentation procedure. In order for a data point in the time-series to be a possible segment boundary (landmark), one of the six types of transitions should occur at the data point: ‘U’ to ‘D’, ‘U’ to ‘S’, ‘D’ to ‘U’, ‘D’ to ‘S’, ‘S’ to ‘U’, and ‘S’ to ‘D’. ‘U’ to ‘D’ and ‘D’ to ‘U’ transitions occur at the extremes of the time-series xₜ. Therefore, initially all the extremes are classified as landmarks by the algorithm. At each time t, whether or not the data point xₜ is an extreme can be tested by multiplying the leftward slope by the rightward slope: (xₜ−xₜ₋₁)×(xₜ₊₁−xₜ). A negative sign indicates that xₜ is an extreme. Transitions involving ‘S’ can be detected again by checking the leftward and the rightward slopes. If and only if one of the two slopes is zero or its absolute value is small enough (less than a user specified threshold εₛₗₒₚₑ) to be considered as a possible start or end of a stationary segment, xₜ is classified as a landmark by the algorithm. εₛₗₒₚₑ was set at 1 deg/min in dealing with joint angle trajectories. A logic describing the landmark detection procedure is as follows:

l_{I} = 1
i = 2
FOR iter=2 TO (T − 1)

```
IF ((xᵢₜₑᵣ − xᵢₜₑᵣ₋₁) x (xᵢₜₑᵣ₊₁ − xᵢₜₑᵣ) <0) OR
  (|xᵢₜₑᵣ − xᵢₜₑᵣ₋₁| ≦ εₛₗₒₚₑ) AND (|xᵢₜₑᵣ₊₁ − xᵢₜₑᵣ| ≧ εₛₗₒₚₑ) OR
  (|xᵢₜₑᵣ₊₁ − xᵢₜₑᵣ| ≦ εₛₗₒₚₑ) AND (|xᵢₜₑᵣ − xᵢₜₑᵣ₋₁| ≧ εₛₗₒₚₑ)
```

THEN

lᵢ = iter
i=i+1

ENDIF
ENDFOR
lᵢ = T
I = i (= The number of landmarks in xₜ)

The procedure outputs the occurrence times of landmarks. The landmark detection algorithm was applied to the example time-series with the threshold value of 1 deg/min.

Segment Boundary Selection (Step 2)

Once landmarks are identified, the algorithm proceeds to divide the time-series into segments. Each landmark is a potential segment boundary at which a segment begins or ends. However, not all of the landmarks might be segment boundaries in the presence of transient, insignificant fluctuations, noises, or ambiguities.

In order to select major segment boundaries, whether or not each landmark meets the following conditions is examined:
The landmark is located farther than a predetermined threshold εₜᵢₘₑ from at least one of the adjacent landmarks in the time axis.
The landmark is located farther than a predetermined threshold εₜᵢₘₑ from the nearest segment boundary (which has been found up to that point) in the time axis.

The first condition ensures that the landmark adjoins at least one segment. The second condition ensures that no two segment boundaries are too close to each other in time. If a landmark satisfies the above conditions, it is determined as a segment boundary. The first and the last data point of a time-series are segment boundaries by definition. εₜᵢₘₑ be set at ⅙ sec for discrete goal oriented movements such as reach or lifting, since 6 Hz is a widely used cut-off frequency for analyzing various forms of natural human movement data. A logic describing the segment boundary selection procedure is as follows:

B = [1]
FOR iter = 2 TO (I−1)

p = lᵢₜₑᵣ − lᵢₜₑᵣ₋₁
q = lᵢₜₑᵣ₊₁ − lᵢₜₑᵣ
u = lᵢₜₑᵣ − b_{end}
IF (((p≧εₜᵢₘₑ) OR (q≧εₜᵢₘₑ)) AND (u≧εₜᵢₘₑ))
THEN

ADD(B, lᵢₜₑᵣ)

ENDIF

ENDFOR
p = l_{I} − b_{end}
IF (p≧εₜᵢₘₑ)
THEN

ADD(B,I)

ELSE

DELETE_LAST(B)
ADD(B,I)

ENDIF
J= (the number of elements in B)−1

The procedure outputs the occurrence times of segment boundaries.

Assign a Symbol to Each Segment to Describe its Shape (Step 3):

After the time-series is divided into major segments, the algorithm will assign symbols to segments to describe their shape. A symbol among three (‘U’, ‘D’, and ‘S’) will be chosen and given to each segment, according to the displacement of the time-series during each segment: If the displacement is greater than or equal to a user-defined threshold ε_{Δx}^{U}, the symbol ‘U’ is assigned to the segment. If the displacement is less than or equal to ε_{Δx}^{D}, the symbol ‘D’ is assigned to the segment. Finally, the symbol ‘S’ will be given, if the displacement value is less than ε_{Δx}^{U}, and greater than ε_{Δx}^{D}·ε_{Δx}^{U}, and ε_{Δx}^{D}, are set as 0.3˜0.7 degrees. A logic description of the symbol assignment procedure is as follows:

C = [ ]
FOR iter = 1 TO J

Δx = x_{b}_{ᵢₜₑᵣ₊₁} − x_{b}_{ᵢₜₑᵣ}
IF (Δx ≧ ε_{Δx}^{U})
THEN

ADD(C, ‘U’)

ELSEIF (Δx ≦ ε_{Δx}^{D})
THEN

ADD(C,‘D’)

ELSE
THEN

ADD(C,‘S’)

ENDIF

ENDFOR

Eliminate Possible Redundancies in the Symbolic Representation (Step 4):

The symbolic representation produced from Steps 1, 2 and 3 may contain redundancies, i.e., consecutive segments with identical symbols: For example, our example time-series was described as ‘SDDSDUSU’ which can be further simplified as ‘SDSDUSU.’ Possible redundancies are eliminated in the segmentation by merging consecutive segments with identical symbols. A logic description of the redundancy elimination procedure is as follows:

B* =[b₁]
C* =[c₁]
FOR iter = 2 TO J

IF (cᵢₜₑᵣ ≠ c*_{end})
THEN

ADD(B*,bᵢₜₑᵣ)
ADD(C*,cᵢₜₑᵣ)

ENDIF

ENDFOR
ADD(B*,T)
OUTPUT B* AND C*

1. A method for predicting an output motion from a database of motion data, the method comprising:
receiving inputs which represent an input motion scenario;
receiving motion data retrieved from the database wherein the motion data represents an existing motion of an existing motion scenario similar to the input motion scenario; and
modifying the motion data based on the inputs to predict the output motion wherein the output motion substantially satisfies the input motion scenario and also substantially retains at least one property of the existing motion.

2. The method as claimed in claim 1, wherein the at least one property is overall angular movement pattern of the existing motion.

3. The method as claimed in claim 1, wherein the at least one property is inter-joint coordination of the existing motion.

4. The method as claimed in claim 1, wherein the existing motion is represented as a set of joint angle trajectories.

5. The method as claimed in claim 4, wherein the step of modifying includes the step of resolving each joint angle trajectory into geometric primitive segments.

6. The method as claimed in claim 1, wherein motions are human motions.

7. The method as claimed in claim 1, wherein the step of modifying is performed in the angle-time domain.

8. The method as claimed in claim 1, wherein the input motion scenario includes a set of attributes which describe a performer and a task.

9. The method as claimed in claim 8, wherein the set of attributes which describe the performer includes at least one of stature, body weight, age and gender.

10. The method as claimed in claim 8, wherein the set of attributes which describe the task includes at least one of motion type, goals of the motion and hand-held object characteristics.

11. The method as claimed in claim 10, wherein the goals of the motion are represented as a set of locations and orientations.

12. The method as claimed in claim 5, wherein each joint angle trajectory is resolved to obtain a plurality of segments and segment boundary points and wherein the step of resolving includes the step of relocating the segment boundary points in the angle-time domain to obtain a new set of segment boundary points and wherein the step of resolving further includes the steps of shifting and proportionately rescaling the segments to obtain new segments and fitting the new segments through the new set of segment boundary points.

13. The method as claimed in claim 1, further comprising searching the database based on the inputs to retrieve the motion data.

14. A system for predicting an output motion from a database of motion data, the system comprising:
means for receiving inputs which represent an input motion scenario;
means for receiving motion data retrieved from the database wherein the motion data represents an existing motion of an existing motion scenario similar to the input motion scenario; and
means for modifying the motion data based on the inputs to predict the output motion wherein the output motion substantially satisfies the input motion scenario and also substantially retains at least one property of the existing motion.

15. The system as claimed in claim 14, wherein the at least one property is overall angular movement pattern of the existing motion.

16. The system as claimed in claim 14, wherein the at least one property is inter-joint coordination of the existing motion.

17. The system as claimed in claim 14, wherein the existing motion is represented as a set of joint angle trajectories.

18. The system as claimed in claim 17, wherein the means for modifying includes means for resolving each joint angle trajectory into geometric primitive segments.

19. The system as claimed in claim 14, wherein motions are human motions.

20. The system as claimed in claim 14, wherein the means for modifying is performed in the angle-time domain.

21. The system as claimed in claim 14, wherein the input motion scenario includes a set of attributes which describe a performer and a task.

22. The system as claimed in claim 21, wherein the set of attributes which describe the performer includes at least one of stature, body weight, age and gender.

23. The system as claimed in claim 21, wherein the set of attributes which describe the task includes at least one of motion type, goals of the motion and hand-held object characteristics.

24. The system as claimed in claim 23, wherein the goals of the motion are represented as a set of locations and orientations.

25. The system as claimed in claim 18, wherein each joint angle trajectory is resolved to obtain a plurality of segments and segment boundary points and wherein the means for resolving includes means for relocating the segment boundary points in the angle-time domain to obtain a new set of segment boundary points and wherein the means for resolving further includes means for shifting and proportionately resealing the segments to obtain new segments and means for fitting the new segments through the new set of segment boundary points.

26. The system as claimed in claim 14, further comprising means for searching the database based on the inputs to retrieve the motion data.

27. A computer program product comprising a computer-readable medium, having thereon:
computer program code means, when the program is loaded, to make the computer execute procedure;
to receive inputs which represent an input motion scenario;
to receive motion data retrieved from a database wherein the motion data represents an existing motion of an existing motion scenario similar to the input motion scenario; and
to modify the motion data based on the inputs to predict the output motion wherein the output motion substantially satisfies the input motion scenario and also substantially retains at least one property of the existing motion.

28. The product as claimed in claim 27, wherein the at least one property is overall angular movement pattern of the existing motion.

29. The product as claimed in claim 27, wherein the at least one property is inter-joint coordination of the existing motion.

30. The product as claimed in claim 27, wherein the existing motion is represented as a set of joint angle trajectories.

31. The product as claimed in claim 30, wherein the motion data is modified by resolving each joint angle trajectory into geometric primitive segments.

32. The product as claimed in claim 27, wherein motions are human motions.

33. The product as claimed in claim 27, wherein the motion data is modified in the angle-time domain.

34. The product as claimed in claim 27, wherein the input motion scenario includes a set of attributes which describe a performer and a task.

35. The product as claimed in claim 34, wherein the set of attributes which describe the performer includes at least one of stature, body weight, age and gender.

36. The product as claimed in claim 34, wherein the set of attributes which describe the task includes at least one of motion type, goals of the motion and hand-held object characteristics.

37. The product as claimed in claim 36, wherein the goals of the motion are represented as a set of locations and orientations.

38. The product as claimed in claim 31, wherein each joint angle trajectory is resolved to obtain a plurality of segments and segment boundary points and wherein the segment boundary points are relocated in the angle-time domain to obtain a new set of segment boundary points and wherein segments are shifted and proportionately rescaled to obtain new segments and the new segments are fitted through the new set of segment boundary points.

39. The product as claimed in claim 27, wherein the code means further makes the computer execute procedure to search the database based on the inputs to retrieve the motion data.
